(19) United States
(12) Patent Application Publication
(10) Pub. No.: US 2020/0003323 A1
(43) Pub. Date: Jan. 2, 2020

(54) DIRECT ACTION SOLENOID VALVE

(71) Applicant: Runner (Xiamen) Corp., Xiamen (CN)

(72) Inventors: QING-PING WANG, Xiamen (CN); YI-MIN LIN, Xiamen (CN)

(21) Appl. No.: 16/449,377

(22) Filed: Jun. 22, 2019

(30) Foreign Application Priority Data
Jun. 28, 2018 (CN) 201821011468.0

(51) Int. Cl. F16K 31/06; F16K 17/04; F16K 31/04

(52) U.S. Cl. CPC F16K 31/0606; F16K 31/046; F16K 17/048

(57) ABSTRACT

A direct action solenoid valve includes: a valve body, on the valve body is disposed a water inlet port and two water outlet ports, the two water outlet ports are a first water outlet port and a second water outlet port respectively; a first water passage channel, formed between the water inlet port and the first water outlet port, and a second water passage channel, formed between the water inlet port and the second water outlet port; a chamber, formed between the first water passage channel and the second water passage channel; a control piece, disposed in the chamber, to control the first water outlet port to open; a solenoid valve head, disposed in the valve body; and a hydroelectric generator, disposed in the valve body to supply power to the solenoid valve head.

### BACKGROUND OF THE INVENTION

### Field of the Invention

The present invention relates to a solenoid valve, and in particular to a direct action solenoid valve.

### The Prior Arts

Presently, a single valve head type solenoid valve is only capable of controlling switching of one water route, and in order to control switching of two water routes, then two valve heads are required. However, the shortcomings of this design are that, to power provided by a hydroelectric generator is not sufficient to bring the two valve heads into action, while the cost of using two valve heads is high.

Therefore, presently, the design and performance of the solenoid valve is not quite satisfactory, and it leaves much room for improvements.

### SUMMARY OF THE INVENTION

In view of the problems and drawbacks of the prior art, the present invention provides a direct action solenoid valve, that is provided with one water inlet port and two water outlet ports, to realize the intelligent switching control of two water routes on the basis of using a single valve head.

The present invention provides a direct action solenoid valve, that includes: a valve body, on the valve body is disposed a water inlet port and two water outlet ports, the two water outlet ports are a first water outlet port and a second water outlet port respectively; a first water passage channel is formed between the water inlet port and the first water outlet port, a second water passage channel is formed between the water inlet port and the second water outlet port; a chamber is formed between the first water passage channel and the second water passage channel; a control piece is disposed in the chamber, to control the first water outlet port to open, the second water outlet port to open, or both the first water outlet port and the second water outlet port to close at the same time; a solenoid valve head is disposed in the valve body, to control open or close of the first water passage channel; and a hydroelectric generator is disposed in the valve body to supply power to the solenoid valve head.

In an aspect of the present invention, the control piece includes an axial compression piece and a switching bolt. A spring is disposed between the axial compression piece and the switching bolt, and a tight seal ring is disposed on the switching bolt.

In another aspect of the present invention, a position restricting face is disposed at one end of the axial compression piece, a first protrusion column is disposed at the other end of the axial compression piece, a sinking groove is disposed at one end of the switching bolt, and a second protrusion column is disposed at the other end of the switching bolt.

In yet another aspect of the present invention, a cooperation face is disposed in the valve body acting in cooperation with the position restricting face, and an indent groove is disposed in the valve body acting in cooperation with the second protrusion column.

In a further aspect of the present invention, one end of the spring is connected to and acting in cooperation with first protrusion column, while the other end of the spring is connected to and acting in cooperation with the sinking groove.

In an aspect of the present invention, the tight seal ring includes a first tight seal ring and a second tight seal ring. The first tight seal ring is used to ensure tight seal of the second water passage channel, and the second tight seal ring is used to ensure tight seal between the first water passage channel and the second water passage channel.

In another aspect of the present invention, a water separation part is disposed in the valve body, and a water inlet channel is disposed between the water inlet port and the water separation part.

In yet another aspect of the present invention, a hydroelectric generator is disposed in the water inlet channel.

In a further aspect of the present invention, a ball head is connected to and acting in cooperation with the valve body.

In an aspect of the present invention, the ball head is fixed to the valve body through using a lock tight nut, and a C shape ring is disposed between the ball head and the lock tight nut.

Compared with the Prior Art, the direct action solenoid valve of the present invention has the advantages:

1. In the present invention, only a single solenoid valve head and two water outlet ports are required, to realize double water routes switching control by using a single valve head, to reduce cost significantly;

2. A control piece is disposed between the first water passage channel and the second water passage channel, and the control piece controls water routes switching by using the differences of water pressure and spring elastic force, to control water output of the first water outlet and the second water outlet, in achieving energy saving for the power generated by the hydroelectric generator and environment protection; and

3. The hydroelectric generator is disposed in the water inlet channel, due to abundant water flow and momentum in the water inlet channel, better power supply can be provided.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a direct action solenoid valve according to the present invention;

FIG. 2 is a schematic diagram of a direct action solenoid valve in a non water input state according to the present invention;

FIG. 3 is a schematic diagram of a direct action solenoid valve in a first water route state according to the present invention;

FIG. 4 is a schematic diagram of a direct action solenoid valve in a second water route state according to the present invention;

FIG. 5 is a schematic diagram of a spring being compressed in a non water input state according to the present invention;

FIG. 6 is a schematic diagram of a spring being compressed in a first water route state according to the present invention; and

FIG. 7 is a schematic diagram of a spring being compressed in a second water route state according to the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the following, an embodiment is used to describe the various details of the present invention. However, it does not mean that this embodiment represents all the embodiments of the present invention. Other embodiments can be envisaged by people familiar with this field, and thus they all fall into the scope of the present invention.

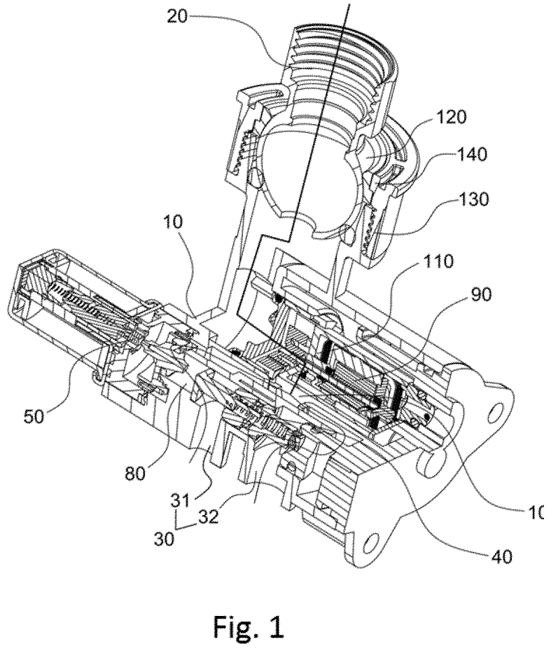

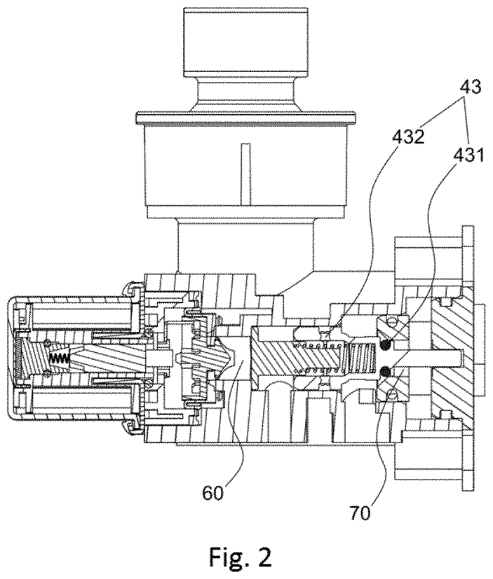

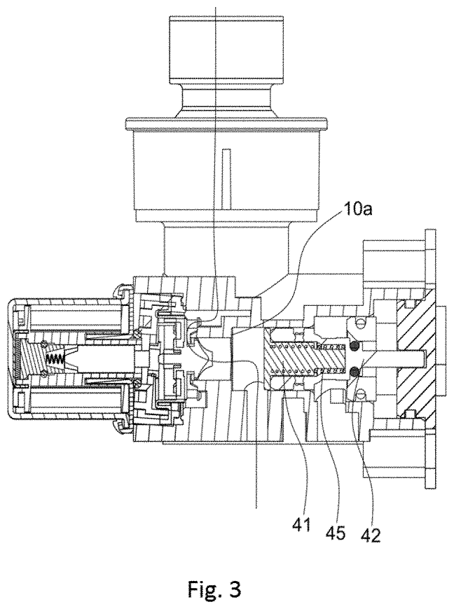

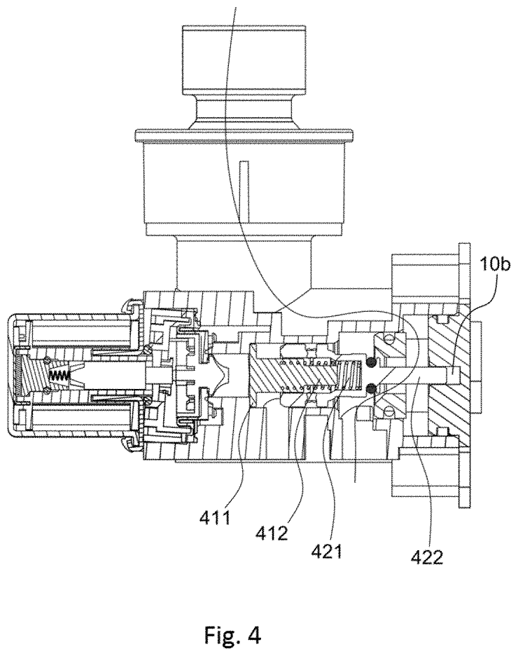

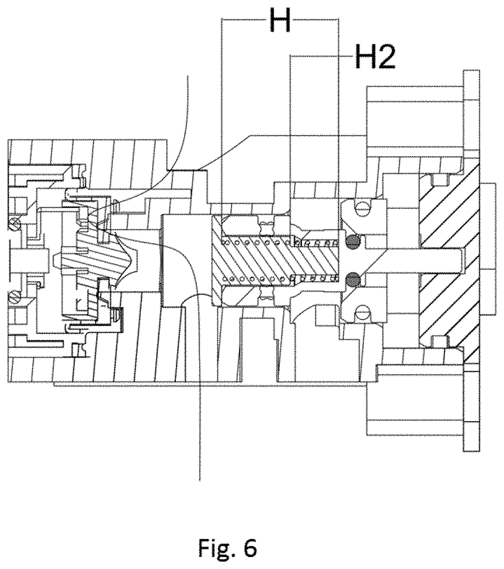

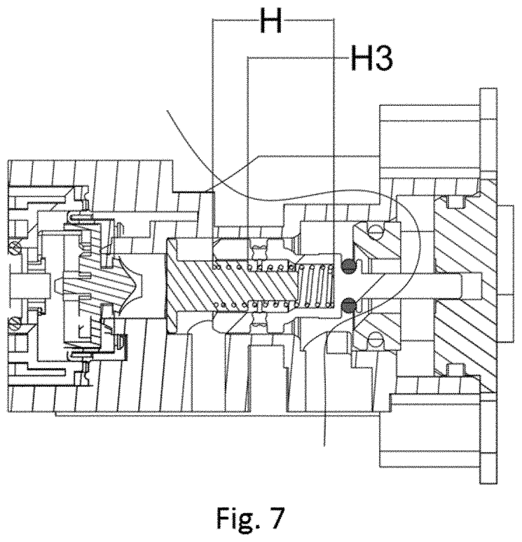

Refer to FIGS. 1 to 7 respectively for a schematic diagram of a direct action solenoid valve according to the present invention; a schematic diagram of a direct action solenoid valve in a non water input state according to the present invention; a schematic diagram of a direct action solenoid valve in a first water route state according to the present invention; a schematic diagram of a direct action solenoid valve in a second water route state according to the present invention; a schematic diagram of a spring being compressed in a non water input state according to the present invention; a schematic diagram of a spring being compressed in a first water route state according to the present invention; and a schematic diagram of a spring being compressed in a second water route state according to the present invention.

As shown in FIGS. 1-7, the present invention provides a direct action solenoid valve, that includes: a valve body 10, on the valve body 10 disposed a water inlet port 20 and two water outlet ports 30, the two water outlet ports 30 are a first water outlet port 31 and a second water outlet port 32 respectively; a first water passage channel 60 is formed between the water inlet port 20 and the first water outlet port 31, a second water passage channel 70 is formed between the water inlet port 20 and the second water outlet 32; a chamber 80 is formed between the first water passage channel 60 and the second water passage channel 70; a control piece 40 is disposed in the chamber 80, to control the first water outlet port 31 to open, the second water outlet port 32 to open, or both the first water outlet port 31 and the second water outlet port 32 to close at the same time; a solenoid valve head 50 is disposed in the valve body 10, to control open or close of the first water passage channel 60; and a hydroelectric generator 90 is disposed in the valve body 10 to supply power to the solenoid valve head 50.

Therefore, a user is able to control open or close of the water routes through using the solenoid valve head 50. As such, when the solenoid valve head 50 is opened, water flows into the first water passage channel 60, to produce impact on one end of the control piece 40, and to make the control piece 40 to move, to open the first water outlet port 31, in achieving a first water route state. When the solenoid valve head 50 is closed, water can not flow into the first water passage channel 60, and it can only flow into the second water passage channel 70, to produce impact on the other end of the control piece 40, to make the control piece 40 to move, and to open the second water outlet port 32, in achieving a second water route state.

In an embodiment of the present invention, the control piece 40 includes an axial compression piece 41 and a switching bolt 42. A spring 45 is disposed between the axial compression piece 41 and the switching bolt 42, and a tight seal ring 43 is disposed on the switching bolt 42.

Firstly, water flows into the valve body 10 of the direct action solenoid valve, such that when the solenoid valve head 50 is opened, water is divided at the water separation part 100. As such, most of water flows through the first water passage channel 60, to produce impact on the axial compression piece 41, and to compress the spring 45 into a length H3. At this time, the switching bolt 42 is at the rightmost end of the chamber 80, such that water flows out from the first water outlet port 31, to achieve the first water route state. When the solenoid valve head 50 is closed, water can not flow into the first water passage channel 60, and after passing through water separation part 100, all the water flows through the second water passage channel 70, to produce impact on the switching bolt 42, to compress the spring 45 into a length H2. At this time, the axial compression piece 41 is located at the leftmost end of the chamber 80. As such, water flows out from the second water outlet port 32, to achieve the second water route state.

In an embodiment of the present invention, a position restricting face 411 is disposed at one end of the axial compression piece 41, a first protrusion column 412 is disposed at the other end of the axial compression piece 41, a sinking groove 421 is disposed at one end of the switching bolt 42, and a second protrusion column 422 is disposed at the other end of the switching bolt 42. One end of the spring 45 is sleeved around the first protrusion column 412, while the other end of the spring 45 is placed in the sinking groove 421.

In an embodiment of the present invention, a cooperation face 10a is disposed in the valve body 10 acting in cooperation with the position restricting face 411, and an indent groove 10b is disposed in the valve body 10 acting in cooperation with the second protrusion column 422.

The space between the cooperation face 10a and the indent groove 10b is formed into a chamber 80, so that the control piece 40 is able to move between the cooperation face 10a and the indent groove 10b. When the position restricting face 411 of the axial compression piece 41 is in contact with the cooperation face 10a, a first limit state, namely the second water route state is reached, to output water from the second water outlet port 32. When the second protrusion column 422 of the switching bolt 42 is in contact with the bottom portion of the indent groove 10b, another state, namely the first water route state is reached, to output water from the first water outlet port 31.

In an embodiment of the present invention, the tight seal ring 43 includes a first tight seal ring 431 and a second tight seal ring 432. The first tight seal ring 431 is used to ensure tight seal of the second water passage channel 70, and the second tight seal ring 432 is used to ensure tight seal between the first water passage channel 60 and the second water passage channel 70.

When the solenoid valve head 50 is opened, the first tight seal ring 431 blocks the second water passage channel 70, so that water leakage will not occur at the second water outlet port 32. Due to the existence of the second tight seal ring 432, when water enters into the chamber 80, water leakage will not occur between the first water passage channel 60 and the second water passage channel 70.

In an embodiment of the present invention, a water separation part 100 is disposed in the valve body 10, and a water inlet channel 110 is disposed between the water inlet port 20 and the water separation part 100.

When water flows into the valve body 10, it will first flow through the water inlet channel 110, then the water flows through the water separation part 100. Under the control of the solenoid valve head 50, the water will flow through first water passage channel 60 or the second water passage channel 70, in achieving the first water outlet state or the second water outlet state respectively.

In an embodiment of the present invention, a hydroelectric generator 90 is disposed in the water inlet channel 110. Since water is not divided or diverted in the water inlet channel 110, it has better flow speed and momentum. Thus, when the hydroelectric generator 90 is placed in the water inlet channel 110, the hydroelectric generator 90 is able to produce more power, for the stable operation of the solenoid valve head 50.

In an embodiment of the present invention, a ball head 120 is connected to and acting in cooperation with the valve body 10. The disposition of the ball head 120 is to change the water flow direction, to increase the operation flexibility of the present invention.

In an embodiment of the present invention, the ball head 120 is fixed to the valve body 10 through using a lock tight nut 130, and a C shape ring 140 is disposed between the ball head 120 and the lock tight nut 130. The purpose of the C shape ring 140 is to increase the stability when connecting and fixing the lock tight nut 130, to ensure stable connection of the ball head 120 and the valve body 10.

In application, when no water flows into the valve body 10, since the control piece 41 is subjected to the elastic force of the spring 45, the position restricting face 411 of the axial compression piece 41 is in contact with the cooperation face 10a, the second protrusion column 422 is in contact with the bottom portion of the indent groove 10b, while the spring 45 is compressed to a length of H1. At this time, the elastic force is F=K*(H−H1), wherein K is the elastic coefficient of the spring 45, and H is the free length of the spring 45. In the first water route state, the solenoid valve head 50 is opened, and the first water passage channel 60 is opened. Then, water flows into the water inlet channel 110, and then to the first water passage channel 60 after passing through the water separation part 100. Consequently, water flow produces impact on the axial compression piece 41, to make the control piece 40 to move to the right due to the flow of water, such that the first tight seal ring 431 blocks the second water passage channel 70 completely. At this time the spring 45 is compressed into a length H2, while the elastic force produced by the spring 45 is F1=K*(H−H2).

In the second water route state, the solenoid valve head 50 is opened, and the first water passage channel 60 is closed. Then, water flows into the water inlet channel 110, and then to the second water passage channel 70 after passing through the water separation part 100. Therefore, water flow produces impact on the switching bolt 42, to make the control piece 40 to move to the left due to the flow of water, such that the position restricting face 411 of the axial compression piece 41 is in contact with the cooperation face 10a, the first tight seal ring 431 is made not to block the second water passage channel 70. At this time, the spring 45 is compressed to a length of H3, while the elastic force F2=K*(H−H3) is produced by the spring 45. When the solenoid valve head 50 is opened, the impact of water pressure on the axial compression piece 41 is greater than that on the switching bolt 42. Therefore, when the solenoid valve head 50 is opened, the control piece 40 is at the rightmost end of the chamber 80, so that water is not output from the second water outlet port 32.

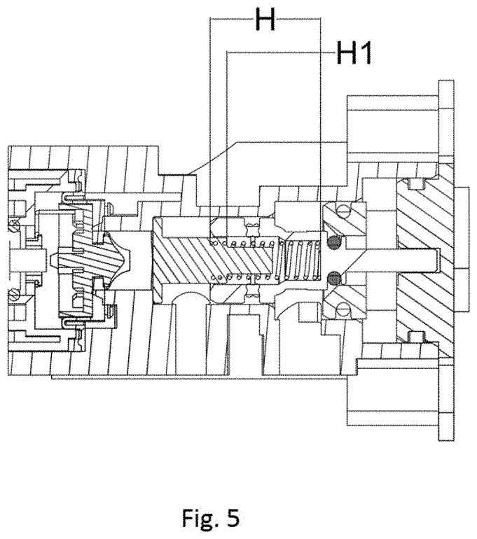

As shown in FIGS. 5-7, after compressions, the resulting lengths of the spring 45 are H>H1>H3>H2 respectively, as such it could produce elastic force F<F2<F1. In the second water route state, it only requires a force slightly greater force than the elastic force of the spring 45, to make the first tight seal ring 431 not block the second water passage channel 70, to realize water output at the second water outlet port 32. In addition, in the first water route state, the spring 45 is able to produce greater elastic force, to make the first tight seal ring 431 block tightly the second water passage channel 70. Therefore, even the switching bolt 42 is subjected to the impact of high pressure, water leakage will not occur, to ensure operation stability of the direct action solenoid valve, when pressure of water is high or low.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A direct action solenoid valve, comprising a valve body, on the valve body is disposed a water inlet port and two water outlet ports, the two water outlet ports are a first water outlet port and a second water outlet port respectively; a first water passage channel is formed between the water inlet port and the first water output port, a second water passage channel is formed between the water inlet port and the second water output; a chamber is formed between the first water passage channel and the second water passage channel; a control piece is disposed in the chamber, to control the first water outlet port to open, the second water outlet port to open, or both the first water outlet port and the second water outlet port to close at the same time; a solenoid valve head is disposed in the valve body, to control open or close of the first water passage channel; and a hydroelectric generator is disposed in the valve body to supply power to the solenoid valve head.

2. The direct action solenoid valve as claimed in claim 1, wherein the control piece includes an axial compression piece and a switching bolt, a spring is disposed between the axial compression piece and the switching bolt, and a tight seal ring is disposed on the switching bolt.

3. The direct action solenoid valve as claimed in claim 2, wherein a position restricting face is disposed at one end of the axial compression piece, a first protrusion column is disposed at the other end of the axial compression piece, a sinking groove is disposed at one end of the switching bolt, and a second protrusion column is disposed at the other end of the switching bolt.

4. The direct action solenoid valve as claimed in claim 3, wherein a cooperation face is disposed in the valve body acting in cooperation with the position restricting face, and an indent groove is disposed in the valve body acting in cooperation with the second protrusion column.

5. The direct action solenoid valve as claimed in claim 3, wherein one end of the spring is connected to and acting in cooperation with first protrusion column, the other end of the spring is connected to and acting in cooperation with the sinking groove.

6. The direct action solenoid valve as claimed in claim 2, wherein the tight seal ring includes a first tight seal ring and a second tight seal ring, the first tight seal ring is used to ensure tight seal of the second water passage channel, and the second tight seal ring is used to ensure tight seal between the first water passage channel and the second water passage channel.

7. The direct action solenoid valve as claimed in claim 1, wherein a water separation part is disposed in the valve body, and a water inlet channel is disposed between the water inlet port and the water separation part.

8. The direct action solenoid valve as claimed in claim 7, wherein a hydroelectric generator is disposed in the water inlet channel.

9. The direct action solenoid valve as claimed in claim 7, wherein a ball head is connected to and acting in cooperation with the valve body.

10. The direct action solenoid valve as claimed in claim 9, wherein the ball head is fixed to the valve body through using a lock tight nut, and a C shape ring is disposed between the ball head and the lock tight nut.
